(19) United States
(12) Patent Application Publication
(10) Pub. No.: US 2007/0112810 A1
(43) Pub. Date: May 17, 2007

(54) Method for compressing markup languages files, by replacing a long word with a shorter word

(76) Inventor: Mattias Jonsson, Goteborg (SE)

Correspondence Address: NIXON & VANDERHYE, PC, 901 NORTH GLEBE ROAD, 11TH FLOOR, ARLINGTON, VA, 22203, US

(21) Appl. No.: 10/563,059

(22) PCT Filed: Jul. 8, 2003
(86) PCT No.: PCT/SE03/01187

§ 371 Date: Jan. 3, 2006

(51) Int. Cl. G06F 7/00; G06F 15/16; G06F 17/00

(52) U.S. Cl. 707/101; 715/513; 709/247

(57) ABSTRACT

The invention relates to a method of compressing data and in particular a method for compressing a data set having a markup hierarchy and comprising data parts having first values, said data set being arranged according to a definition part, the method comprising the steps of: assigning at least said markup hierarchy defining said data parts defined in said definition part with codes having less values than said first values, and replacing said data parts in said data set by said assigned codes and producing a compressed data set. The invention is in a preferred embodiment particularly related to markup languages as XML, SGML or similar.

### FIELD OF INVENTION

This invention relates in general to compression of information, and in particular, to compression of markup language documents.

### BACKGROUND OF THE INVENTION

In the area of telecommunication or data communication and similar or related areas it is necessary to exchange information between various environments, e.g. between different data programs, different databases and different software and hardware platforms etc.

A prerequisite in all information exchange is that the receiver and the transmitter interpret and understand the exchanged information in the same way. This may e.g. be accomplished by developing special data-forms defining the structure of the information to be exchanged, where both the transmitter and the receiver use the same data-form.

Such data-forms are normally tightly connected to the specific environment, e.g. Incorporated in the executable computer code of the specific application. This has the benefit of enabling an exchange of small and bandwidth efficient packets of information (data-packets). On the other hand, a data-form that is tightly connected to a specific environment becomes rather static and it is virtually impossible to use an existing data-form to exchange information with another structure than the present information. Consequently, any modifications in the information structure will demand an adaptation of the data-form.

Consequently, a tight connection between a specific environment and the used data-form implies that the environment has to be redesigned when the information structure changes, e.g. bring about a redesign of the executable computer code of the specific application. This makes it hard and costly to maintain the system in a dynamic environment.

In addition, data-forms designed for a specific environment are usually not capable of supporting an information exchange with other environments, e.g. other applications or other platforms. A well-known solution is then to develop different parsers for rearranging the specific information structure to fit other environments. For example, information transmitted from a specific application or a specific platform may be parsed to fit another receiving application or platform. However, similar to adaptations for changes in an internally used data-form a drawback with the parser approach is that the parser has to be redesigned to changes in the information structure, e.g. redesign of the computer code of the specific parser, which again makes it hard and costly to maintain the system in a dynamic environment.

Another more dynamic solution is to use a two-part data-form. Here, the structure of the exchanged information is defined in a first part, which may be any data-comprising arrangement, such as a database or even a data file comprising a simple text document etc. This is clearly different from an information structure, which is incorporated into an application program or into a parser program or similar. Further, a second part in the two-part solution comprises the information to be exchanged, which information is arranged according to the structure defined in the first part.

The first part and the second part may be arranged as one unit (e.g. in one data file) or as two separated units (e.g. as two separate data files). However, two separate units normally presupposes that the first unit is exchanged together with the second unit, or that the first unit is otherwise known to the receiver, e.g. pre-stored in the receiving environment or otherwise accessible to the receiving environment.

A two-part solution as briefly described above enables a parser to adapt its operation to the structure of the exchanged information comprised by the second part by considering the information structure defined by the first part. The definition of the information structure enables a general parser to rearrange the exchanged information to fit the receiving environment in question. Accordingly, a two-part solution or similar enables the use of one single parser for handling a multitude of information structures by considering the relevant information structure definition.

This is clearly different from a solution where the structure of the exchanged information is reflected by the parser program itself, since the parser then has to be reprogrammed if the information structure changes. As an alternative to the difficult and costly reprogramming of a parser, the two-part solution provides the possibility to simply rewrite the definition of the information structure comprised by the first part. This can be as easy as editing an existing text document that defines the present information structure.

Moreover, an original definition of the information structure is normally defined in the specification of the system or environment in question. In other words, a text document specifying the information structure is normally available from the design phase of the system or the environment. That text can be edited by simple means to form the first defining part in a two-part solution, e.g. in connection with markup languages as will be explained below.

Various two-part data-forms are known in prior art, wherein a first part defines an information structure and a second part comprises information, arranged according to the defined information structure. Especially, various so-called markup languages have been developed using a two-part data-form.

Markup language refers to a set of markup conventions used for encoding texts, i.e. encoding text documents comprising information to be exchanged between different environments. A markup language may in particular specify what markups is allowed, what markups is required, how a markup is to be distinguished from text, and what the markup means.

The SGML (Standard Generalised Markup Language) is one example of a markup language used for the description of marked-up electronic text. Another example of a similar markup language is the XML (Extensible Markup Language), developed by World Wide Web Consortium (See W3C web page: http://www.w3.org/XML). Such markup languages are metalanguages, i.e. a means of formally describing a language, in this case, a markup language. Both SGML and XML are widely used for the definition of device-independent, system-independent methods of electronic storing and processing of information comprised by texts.

Markup languages as SGML, XML and similar are extensible, i.e. they do not contain a fixed predefined set of tags or similar means of definition. Moreover, a document according to a markup language must be well formed according to a syntax, which is preferably defined by the user, where a specific document may be formally validated to comply with this syntax. Typical markup languages usually have three emphasises in common: first they use a descriptive rather than a procedural markup; second they use a document type concept; and third they are essentially independent of any one of hardware or software system. These three aspects are discussed briefly below.

The first emphasis on a descriptive rather than a procedural markup implies that a markup does little more than categorise or define parts of a document. Markup codes such as <para> simply identify a portion of a document and assert of it that “the following item is a paragraph” etc. By contrast, a procedural markup defines what processing is to be carried out at particular points in a document, e.g. “call procedure PARA” or “move the left margin 2 quads left” etc. Normally, the instructions needed to process a markup document (e.g. to format the document) are sharply distinguished from the descriptive markup in the document. Process instructions and similar are normally collected outside the document in separate procedures or programs, e.g. expressed in a distinct document called a stylesheet. By using a descriptive instead of a procedural markup the same document can be processed in many different ways, using only those parts of it that are considered to be relevant. For example, one program may e.g. extract names of persons and places from a markup document to create an index or a database, while another program, operating on the same document, might print names of persons and places in two distinctive typefaces.

The second emphasis on using a document type concept implies that markup documents are regarded as having types, just as other objects processed by computers. If documents are of known types this enables a computer program, provided with an unambiguous definition of a document type, to check that any document claiming to be of that type does in fact conform to the specification. In particular, different documents of the same type can be processed in a uniform way. Further, programs such as stylesheets and especially parsers or similar can be written to utilise the knowledge encapsulated in the structure of the information comprised by such a document, which e.g. enables a parser to behave in a more intelligent fashion.

The third emphasis on hardware and software independence implies that a basic design goal of markup languages is to ensure that documents encoded according to the provisions of a markup language can move from one hardware and software environment to another without loss of information. One step to enable a hardware and software independence is to let all documents of a specific markup language use the same underlying character encoding. For example, the character encoding in XML is defined by an international standard, (ISO/IEC 10646 Information Technology-Universal Multiple-Octed Coded Character Set (UCS)), which is implemented by a universal character set maintained by an industry group called the Unicode Consortium, and known as Unicode. This provides a standardised way of representing any of the thousands of discrete symbols making up the world's writing systems, past and present. Another possible but more limited character encoding may be the ISO/IEC 646 version of ASCII (American Standard Code for Information Interchange).

A simple and consistent mechanism for a markup or identification of textual structure is e.g. provided by the above-mentioned XML. The two-part nature of XML is reflected by the XML-document and the XML document type definition (DTD), defining the structure of the information in the XML-document. As will be explained, the document type definition (DTD) may be embedded in the XML-document (an internal DTD) or comprised by a separate text file or similar (an external DTD). It should be noted that there are other ways of defining the structure of an XML-document, e.g. by using a so-called XML-schema.

Moreover, a DTD or an XML-schema can be used to check the syntax of a markup document, which means that all markup documents checked and approved by the same key have the same information structure, although they may have different information content.

An XML-document consists of two components, i.e. markups and character data. Markups constitutes the skeleton of the document and instructs a target application or similar how the content may be interpreted and handled. The essential XML-markups are elements attributes, references and process instructions, though there are other XML-markups. Moreover, other markup languages may have other markups. Information in an XML-document that is not markups is regarded as character data.

The XML markup means called tags enclose identifiable parts in a document. Tags allow a document to be divided into a logical structure of named units called elements. A start-tag and an end-tag, together with the data enclosed by them, comprise an element. A simple element may e.g. be <name> Smith</name>, wherein <name> and </name> constitutes the start tag and end tag respectively, wherein “Smith” in this simple example constitutes the character data content of the element. An element may also be empty, e.g. <name></name> or alternatively <name/>.

XML elements often contain further embedded elements. An embedded element must be completely enclosed by another element and the entire document must be enclosed by a single document element, the root-element.

A simple example of a document structure having the root-element “start” endorsing the element “person”, in turn endorsing the elements “name” and “phone”:

```
<start>
  <person>
    <name>Smith</name>
    <phone>+46 31 7470000</phone>
  </person>
</start>
```

The document element structure hierarchy may be visualised as boxes within boxes (or Russian dolls) or as branches of a tree, wherein different types of elements are given different names. However, XML provides no way of expressing the meaning of a particular type of element, other than its relationship to other element types. Rather, it is up to the creators of XML vocabularies to choose intelligible names for the elements they identify and to define their proper use in text markup.

XML also provides for one or several attributes to be embedded in the start-tag of an element. Such attributes supply additional information about an element, where an attribute name is followed by an equal sign and where the attribute value in turn is enclosed by quotes.

An example element attribute is: <name keyaccount=“yes”>Smith</name>, where the attribute “keyaccount” has been allocated the value “yes”.

A target application may use the attribute values in any way it chooses. For example, a formatter may print a “name” element with the “keycustomer” attribute set to “yes” In a different way from a “name” element with the attribute set to “no”. Another target application may use the same attribute to determine whether or not “name” elements are to be processed at all.

In addition, XML provides for the possibility of inserting references to an entity in a markup document. An entity may in its simplest form comprise anything from one character to whole documents of character data, which will replace the reference. References works much like a word processor search and replace function, i.e. a word or a phrase (the entity reference) is located and replaced by another word or phrase (the entity).

An example of an entity reference is:

<letter>&letterhead </letter>

This reference makes it possible to substitute the entity reference “&letterhead” with the content comprised by the entity, e.g. insert letterhead information at the beginning of every letter.

For example, if the entity “letterhead” has been declared to comprise the words “ACME Construction INC”, every instance of the reference “&letterhead” in the markup document will be replaced by the words “ACME Construction INC”.

Although one of the aims of using XML is to remove any information specific to the processing of a document from the document itself, it may nevertheless be convenient to include such information in the document—if only so that it can be clearly distinguished from the structure of the document. Page-breaking decisions for example are usually best executed by the target application formatting-engine or similar, but there will always be occasions when it may be necessary to over-ride these. An XML processing instruction inserted into the document is one effective way of doing this without interfering with other aspects of the markup.

An XML-processing instruction begins with <? and ends with ?> and an example processing instruction may be: <?tex newpage ?>. By convention, the first part is the name of some processor (tex in the above example) and the second part is some data intended for the use of that processor (in this case, the instruction to start a new page).

Another example of a XML processing instruction is the XML-declaration <?xml?>, which is the most commonly used process instruction. This XML-declaration, also known as the prologue, appears at the start of an XML-document to impart some important information about that document. The XML-declaration may contain three pieces of information: the version of XML in use; the character set in use; and if the document type definition to actuate an interpretation of the document is embedded in the document itself or comprised by a separate entity (e.g. comprised by a separate file).

An example of an XML-declaration is:

<?xml version=“1.0” encoding=“utf-8” standalone=“yes”?>.

According to this XML-declaration the document in question uses XML version 1.0 and an eight bit Unicode encoding (encoding=“utf-8”). Further it announces that the document includes all the necessary document type definitions (standalone=“yes”), i.e. the document do not use any external document type definition files or similar. However, an external document type definition file or similar is preferred in connection with information exchange, however not a prerequisite. Document type definition (DTD) will be discussed more extensively below. However, it should be noted that there are other ways of defining the structure of an XML-document, e.g. by using a so-called XML-schema.

Declarations and the Document Type Definition (DTD)

In the outline of the XML-document above processing instructions were mentioned, which are intended for the target application. Another such instruction of significance intended for the XML-processor is the document type declaration, indicated by the keyword “DOCTYPE”. If the document type declaration is used it must appear before the root-element, i.e. before the document start-tag. A simple document type declaration is <!DOCTYPE mydocument>, which merely identifies the name of the root-element (mydocument). More complex variants are used to hold the document type definition (DTD). When such a DTD is used it is enclosed by square brackets, e.g.:

<!DOCTYPE mydocument [!ELEMENT name (#PCDATA)]>

Here, the document “mydocument” has been defined to hold one single element, namely the element “name”, which in turn has been defined to hold “Parsable Character Data”. A “Parsable Character Data” may e.g. be the name “Smith” or some other character data. Further, in this example the DTD is incorporated in the document “mydocument”, i.e. the document uses an internal DTD. This corresponds to standalone=“yes” in the XML-declaration processing instruction, i.e. the prologue as mentioned above. However, an external DTD can be declared by using the keyword “DOCTYPE” followed by the name of the root-element of the associated document and e.g. the keyword “PUBLIC” followed by the name of the external file or similar.

An example illustrating the declaration of an external DTD may be:

<!DOCTYPE start PUBLIC “http://www.internet.com/xml/definitions/start.dtd”>

Here, “start” is the root-element of the associated document and the external DTD is located at the web-address “http://www.internet.com/xml/definitions” in a file named “start.dtd”. The keyword “PUBLIC” indicates that other applications may access the DTD-file, which may be preferable if several applications exchange XML-documents comprising different information, however arranged according to the structure defined in the DTD.

Considering the outline of the XML-document above wherein elements, attributes, start-tags, end-tags, processing instructions and references were discussed and the discussion regarding declarations so far, a short exemplifying XML-document may be:

```
<?xml version=“1.0” encoding=“utf-8” standalone=“no”?>.
<!DOCTYPE start PUBLIC
“http://www.internet.com/xml/definitions/start.dtd”>
<start>
  <person keyaccount=“yes”>
    <letter>&letterhead;</letter>
    <lastname>Smith</lastname>
    <firstname>John</firstname>
    <age>45</age>
    <phone>+46 31 7470000</phone>
  </person>
</start>
```

An XML DTD defining the exemplified XML-document above, may be:

<!ENTITY letterhead “ACME Construction INC ”>
<!ELEMENT start (person)>
<!ELEMENT person (letter, lastname, firstname, age, phone)>
<!ATTLIST person keyaccount (yes | no) #IMPLIED>
<!ELEMENT letter (#PCDATA)>
<!ELEMENT lastname (#PCDATA)>
<!ELEMENT firstname (#PCDATA)>
<!ELEMENT age (#PCDATA)>
<!ELEMENT phone (#PCDATA)>

In this DTD the entity “letterhead” has been allocated the character data “ACME Construction INC”, which will replace every occurrence of the entity reference “&letterhead” in the XML-document. The root-element “start” has been defined to comprise the element “person”, where and “person” has been defined to comprise the elements “letter”, “lastname”, “firstname”, “age” and “phone” in turn defined to comprise Parsable Data (#PCDATA). In addition, the element “person” has been defined to comprise the attribute “keyaccount”. The attribute has in turn been defined by the keyword “#IMPLIED”, indicating that no value need to be supplied to the attribute “keyaccount”, while the qualifiers “yes” and “no” Indicates that if “keyaccount” is supplied with a value it must be “yes” or “no”, and nothing else.

XML provides for several other qualifications of elements and attributes. An element may e.g. be further defined in a DTD by the optional qualifiers: “?”, “*” or “+”, which defines the occurrence of an element. An attribute may e.g. be defined by the alternative qualifiers: CDATA, ID, IDREF, IDREFS, NMTOKEN or NMTOKENS, which defines the kind of value an attribute may assume; and #FIXED, #REQUIRED or #IMPLIED, which defines the occurrence of an attribute value. All these qualifiers are thoroughly defined in the XML-specification and they will not be explained further in this connection.

Moreover, it should be underlined that XML is merely one of several markup languages, and that a document type definition (DTD) or a XML-Schema is merely examples of several possible ways of defining the structure of the information in a markup document or similar. For example, SGML is another suitable markup language, as previously mentioned, whereas e.g. XHTML is a XML-like development of HTML. There are also other XML-versions or extensions of XML, e.g. adapted for representing mathematical or chemical expressions etc.

Conclusion

As can be observed, the example XML-document above only comprises character data in the following positions:

“letter”=“ACME Construction INC”

“person”=“yes”

“lastname”=“Smith”

“firstname”=“John”

“age”=“45”

“phone”=“+46 31 7470000”

The information in the character data may be otherwise expressed as:

“ACME Construction INCyesSmithJohn4546 31 7470000”,

which adds up to 48 characters, blanks included.

However, the full XML-document in the example above comprises more than 300 characters, including the XML-Declaration and the DOCTYP-declaration. Further, the example XML-document still comprises more than 180 characters even if the XML-Declaration and the DOCTYP-declaration is ignored. Obviously, an XML-document comprises a lot of overhead characters. Moreover, the overhead increases, as the XML-document comprises more elements, i.e. more “person” elements in the example above. In essence it is the sum of all markup text—e.g. the names of the elements and attributes etc—that causes the overhead. This is the same for all markup languages, which makes them unsuitable for information exchange in low bandwidth environments. Markup documents are therefore unsuitable for information exchange in low bandwidth environments.

However, markup languages generally provides for a two-part solution as described above. A two-part solution enables a parser to adapt its operation to the structure of the exchanged information comprised by the second part, by considering the information structure defined by the first part. Thus, a parser can remain unchanged even if the structure of the exchanged information varies. This is beneficial, since it avoids difficult and costly reprogramming of parsers to fit different information structures.

Consequently, there is a need for an improvement that permits the use of markup languages or similar two-part solutions for exchange of information in low bandwidth environments.

The patent U.S. Pat. No. 6,510,434 B1 shows a system and method for retrieving information from a database using an index of XML tags and metafiles.

Thus, as a contrast to the present invention this document does not concern a compression of information, regardless if the information is comprised by a text file, a database or some other storage arrangement.

The patent U.S. Pat. No. 6,253,624 B1 shows a coding of network grouping data of the same data type into blocks by using a file data structure and selecting compression for individual block base on block data type. A preferred coding network according to the patent uses an architecture called Base-Filter-Resource (BRF) system. This approach integrates the advantages of format-specific compression into a general-purpose compression tool, serving a wide range of data formats. Source data is parsed into blocks of similar data and each parsed block are compressed using a respectively selected compression algorithm. The algorithm can be chosen from a static model of the data or can be adaptive to the data in the parsed block. The parsed blocks are then combined into an encoded data file. In particular, the system preferably includes a method for parsing source data into individual components. The basic approach, called “structure flipping” provides a key to converting format information into compression models. Structure flipping reorganises the information in a file so that similar components that are normally separated are grouped together.

Thus, this document, as the present invention, discloses a method for compression of information. Moreover, the patent may be understood as describing a two-part solution. However, if that is the case then the first part of that two-part solution comprises a key for compressing information comprised by a second part. In other words, the patent can be understood as a two-art solution then the first part in that two-part solution does not comprise a definition of the structure of the information comprised by the second part. Especially, the key disclosed in the patent does not comprise a definition of the structure of the information comprised by a markup document. In particular, the patent does not describe a compression adapted for using a two-part solution to compress a markup document or the like.

### SUMMARY OF THE INVENTION

As two-part solutions implemented by markup languages and markup documents or similar are unsuitable for exchanging information in low bandwidth environments, due to overhead information primarily caused by the markup text or similar, there is a need for a simple and uncomplicated solution that minimises the overhead information. Thus, the main object of the preferred embodiment of the present invention is to provide a data compression method and arrangement, especially (but not exclusively) for markup data. Therefore, the preferred embodiment of the present invention discloses a way to minimise the overhead by using the first defining part in a two-part solution to create short codes for markup hierarchies defined in the first part, which short codes are used to replace the markup texts in the second part.

Other advantages of the invention are:
providing a slim application and transmission media independent data-form key that can be used for encoding data packets to smaller size;
supplying high level applications with a small solution for transmitting data through low-bandwidth networks, or from a network having a higher capacity to a network having lower capacity;
providing a data-compressor/de-compressor solution that is application and platform independent, wherein local applications and platforms can be developed independently from remote ditto.

In particular, the preferred embodiment of the invention provides a method based on a two-part solution for compressing an amount of information having markup hierarchies, wherein a first part comprises a definition of an information structure and a second part comprises information arranged according to the structure defined in the first part. Moreover, the markup hierarchies defined in the first part can be assigned codes, and markup hierarchies in the second part can be replaced by a code that corresponds to the specific markup hierarchy.

Thus, the invention according to preferred embodiments provides a method for compressing a data set having a markup hierarchy and comprising data parts having first values. The data set is arranged according to a definition part. The method comprises the steps of: assigning at least said data parts with codes having less values than said first values, replacing said data parts in said data set by said assigned codes and producing a compressed data set. According to one embodiment, the markup hierarchy refers to a reference comprising a second markup hierarchy, which are resolved and assigned with codes. Each code is unique and allows an effective compression. Preferably, each code replacing a markup hierarchy in said data set is assigned a value pointed out by said markup hierarchy. According to another preferred embodiment a code replacing a markup hierarchy in said data set is assigned a value comprised by a reference pointed out by said markup hierarchy. A value pointed out by a markup hierarchy in said data set can be one of a limited set of values defined in said data set, where each value is assigned a code that replaces said value in said data set or a value pointed out by a markup hierarchy in said data set is a number and replaced by a numerical representation. Most preferably, the definition part is a document type definition (DTD) or an XML-schema and said data set is a markup document; thus allowing using commonly available components. Most preferably, the markup document is structured according to a markup language as XML, SGML or similar.

The invention also relates to a method of transmitting a data set from a first application to a second application. The data set has a markup hierarchy and comprises data parts having first values. The data set is arranged according to a definition part. The method comprises the steps of: generating a set of codes as a compression key defining said data parts defined in said definition part with codes having less values than said first values, storing said set of codes, assigning at least said markup hierarchy with said set codes, replacing said data parts in said data set by said assigned codes and producing a compressed data set, and transferring said compressed data set and said set of codes to said second application. Most preferably, but depending on the network protocol, the set of codes and said compressed data are transferred in packages. A package comprises at least a message type field, transmitting receiving application identity field, compression key and compressed data. A package may further comprise a message version field, and contains information sent to the Compression Handler, for handling key compression. The compression key is transmitted once or several times with each compress data transmission compressed with respect to said compression key. The transmission can be further enhanced by compressing the compression key. The compressed data is compressed in an additional step, further enhancing the transmission rate.

The invention also relates to a system for data transmission between at least two stations, said data comprising a compressed data set according to any of preceding claims. The system comprises: a Compression part, comprising: a compression Handler for initiating a compression procedure; a Key Handler for generating and handling keys corresponding to codes; a Storage device for handling storage of generated keys; a Converter for implementing a first step in coding of the data set to be compressed by mean of the keys; an Optimizer for implementing a second step in optimizing the data set to be compressed; a Compressor for implementing a third step of compression itself. A Transmission part, comprising: a Transmitter for handling all communication, a Packet handler for generating messages with respect to a Packet for transmission and reception, an interface for listening to data transmission. The system further comprises a Compression Key handler, Compression document handler, a non-compressed data set handler and a Protocol handler. The Transmission Part handles the generation of a unique Application Identity, so that a receiver can Identify incoming data and also the keys having unique identity.

The invention also relates to a program storage device readable by a machine and encoding a program for compressing a data set having a markup hierarchy and comprising data parts having first values, said data set being arranged according to a definition part. The programme comprises: an instruction set for assigning at least said markup hierarchy defining said data parts defined in said definition part with codes having less values than said first values, and an instruction set for replacing said data parts in said data set by said assigned codes and producing a compressed data set.

The invention also relates to a computer readable program code means for causing a computer to compress a data set having a markup hierarchy and comprising data parts having first values, said data set being arranged according to a definition part. The computer readable program code means comprises: an instruction set for assigning at least said markup hierarchy defining said data parts defined in said definition part with codes having less values than said first values, and an instruction set for replacing said data parts in said data set by said assigned codes and producing a compressed data set.

According to the invention An article of manufacture is provided, comprising a computer useable medium having computer readable programs code means embodied therein for causing a compression of a data set having a markup hierarchy and comprising data parts having first values, said data set being arranged according to a definition part. The computer readable program code means in said article of manufacture comprising: an instruction set for assigning at least said markup hierarchy defining said data parts defined in said definition part with codes having less values than said first values, and an instruction set for replacing said data parts in said data set by said assigned codes and producing a compressed data set.

The invention also relates to a propagated signal comprising a computer readable programs code means for causing a compression of a data set having a markup hierarchy and comprising data parts having first values, said data set being arranged according to a definition part. The computer readable program code means in said propagated signal comprising: an instruction set for assigning at least said markup hierarchy defining said data parts defined in said definition part with codes having less values than said first values, and an instruction set for replacing said data parts in said data set by said assigned codes and producing a compressed data set.

The invention also relates to a computer readable medium having stored therein a protocol with plurality of messages for obtaining compressed data from a remote application. The protocol comprising: a request message for receiving a set of compressed data set, a request for receiving a set of codes used for compressing said compressed data set having a markup hierarchy and comprising data parts having first values, said data set being arranged according to a definition part, at least said markup hierarchy defining said data parts defined in said definition part being assigned with codes having less values than said first values, and said data parts being replaced in said data set by said assigned codes, a response comprising said compressed data and said codes, a response comprising identity of application and unique identity of codes.

According to one aspect, a communication system comprising a first unit controlling a second unit communicating through communications network is provided. The first unit sends a data set having a markup hierarchy and comprising data parts having first values. The data set is arranged according to a definition part, the system further comprising a compressing unit and decompressing unit. The compressing unit is arranged to: assign at least said data parts with codes having less values than said first values, replace said data parts in said data set by said assigned codes and producing a compressed data set. The first unit can be any of a mobile station, a mobile phone, a palm size computer, a computer or similar. The first unit can be a remote control or monitoring device. The second unit can be a remotely controlled arrangement such as robot, a vehicle, and a missile.

### BRIEF DESCRIPTIONS OF THE DRAWINGS

A preferred embodiment of the present invention will now be described in more detail, with reference to the accompanying drawings, in which:

FIG. 1 is a flow diagram illustrating blocks of a data communication system transmitting data compressed according to one preferred embodiment of the present invention,

FIG. 2 shows a table of an exemplifying XML-document and its associated document type definition (DTD), supplemented by an exemplifying and associated compressing key and an exemplifying and associated compressed result.

FIG. 3 is a flow diagram illustrating the compression steps,

FIG. 4 is a flow diagram illustrating the key creation steps,

FIG. 5 is a block diagram illustrating the class hierarchy of a exemplary system according to the invention,

FIGS. 6a-6c illustrate message package fields according to one embodiment of the invention, and

FIG. 7 is a block diagram illustrating an exemplary application of one preferred embodiment according to the invention.

### DESCRIPTION OF PREFERRED EMBODIMENTS OF THE INVENTION

In the following preferred embodiments will be described in an exemplary way with reference to an XML data set. However, it should be appreciated that the invention is not limited to XML, but other markup languages can be used.

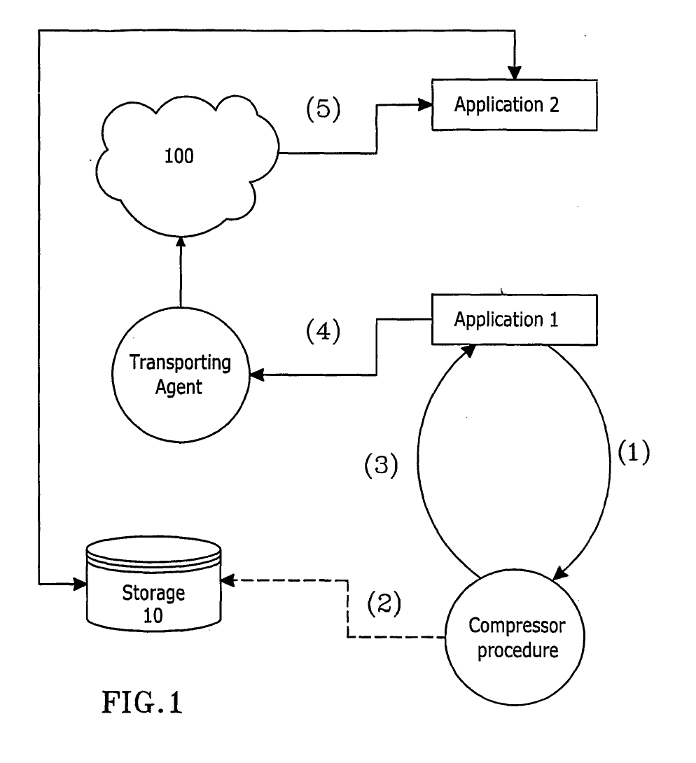

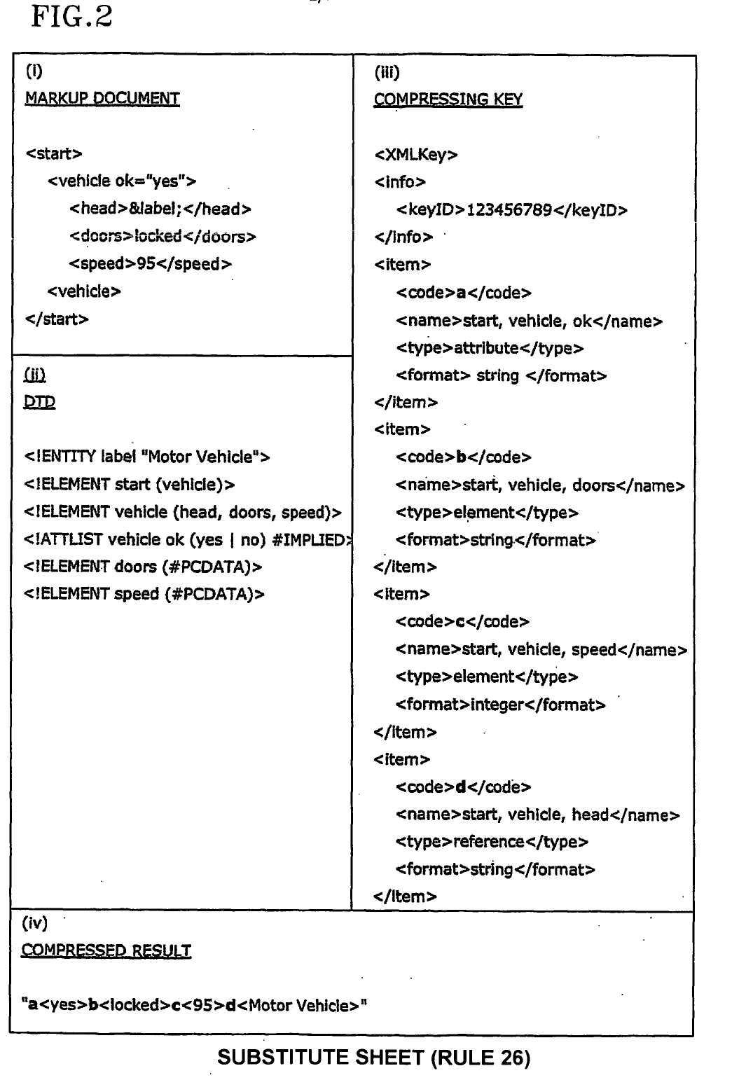

Referring now to FIGS. 1 and 2, main steps of the invention are described. Assume that Application 1 wants to send an XML data set “MARKUP DOCUMENT” (i) in FIG. 2, to Application 2 in a communication network 100. Application 1 calls the Compressor Procedure according to the invention to compress data before it is sent to Application 2.

A first step (1), according to the preferred embodiment of the invention, is to use a DTD (ii) or an XML-schema or some other defining part to create a key (iii) that comprises short codes of substantially all markups that are allowed according to the defining part. The key creation procedure is described in more detail below. The created key is stored (2) in a storage device 10, e.g. in this case realised as a database, and then used in a second step to replace all markups in an associated markup document or some other information comprising part received from Application 1 with the shorter codes that are stored in the key. The compressed result is disclosed in FIG. 2 (iv). In this way the size of the markup document will be reduced significantly. Moreover, the size of the document may be reduced in several steps. The compressed document and the key are returned (3) to Application 1, which sends (5) them through the network 100 to Application 2. The transmission can be done (4) using a Transporting Agent. Transporting Agent is described in more detail below. Moreover, Application 1 may initiate the compression of a markup document for sending a document to Application 2, or by Application 2 for retrieving a document from Application 1. The storage device can be implemented in any location within the network of Application 1; it may also be located so that both applications can access the storage device for obtaining keys and DTD files.

Of course, Application 2 can obtain the key by accessing the storage device (6). Thus, the storage device can be a part of an intranet, Internet, a communications network or communicating devices. The key can be transmitted automatically (described below), retrieved from an storage device or generated in the second application using a common DTD.

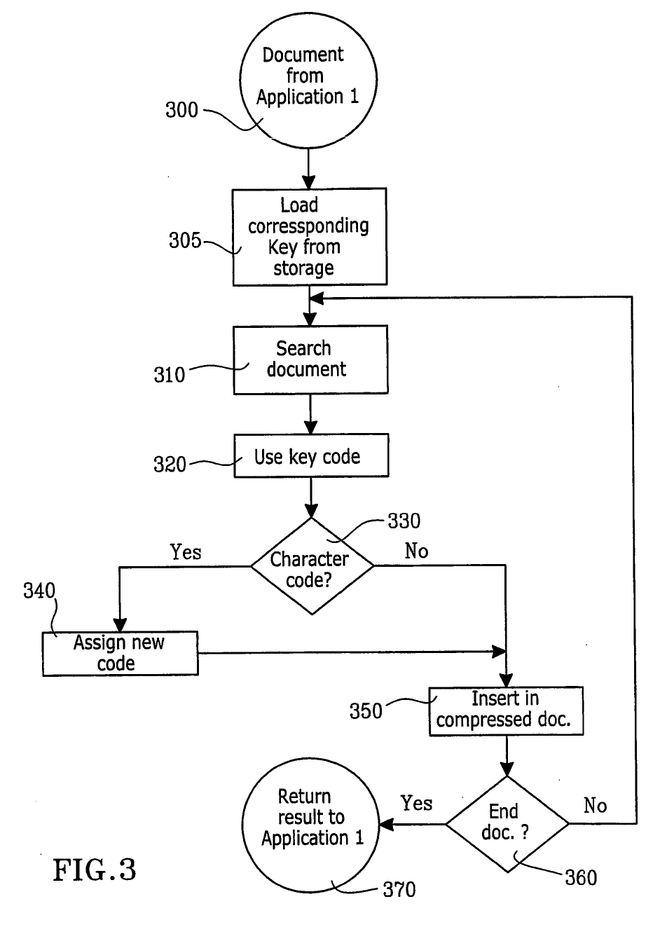

FIG. 3 illustrates the compression procedure that begins with importing 300 a document to be compressed. In a first step a key is imported from a storage device 305.

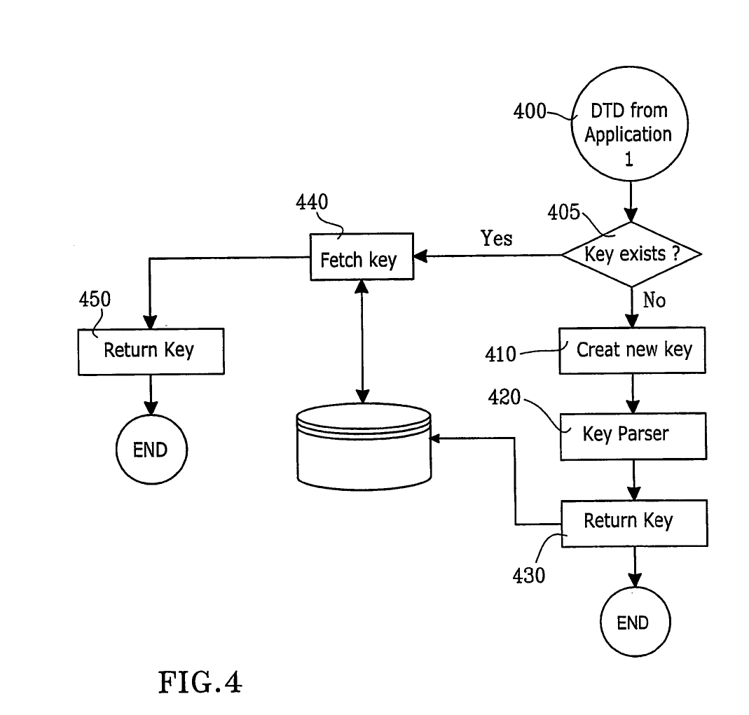

The key creation process is described in more detail in conjunction with description of flow diagram of FIG. 4. The compression starts by going through 310 the document/data set to be compressed, whereupon said Key is used 320 to compress the document. The procedure runs 330 through the document by looking for information corresponding to the Key. If a character code is found, it is substituted 340 with a new code and inserted 350 into the compressed document. Otherwise data (i.e. a value) found is inserted into the compressed document. The procedure is executed until the entire document is searched.

In some applications it may be possible to use a DTD, an XML-schema or another similar or related defining part for a direct compressing of an associated markup document without using a key. However, if a DTD or some other defining part is used for a direct compressing of a markup document the compressing key has to be extracted from the defining part before any compression. This is time-consuming, among other things, and a delay in the exchange of information is normally regarded as a drawback, especially when information is exchanged in real time applications.

To enable an exchange of a compressed markup document, it is necessary to distribute the created compressing key, which has to be used by a receiver to decompress the document. The key in question may be transmitted the first time when an associated document is sent to a specific receiver. The receiver may alternatively demand the key from the transmitter, e.g. if the receiver has lost the key or if the original transmission of the key was unsuccessful.

Moreover, the key must be marked with a unique identification for enabling a receiver to pick the right compressing key associated with the received document to be decompressed. There are several ways of marking a key and one possibility in this connection is to set the identification in the defining part, i.e. in the DTD or the XML-schema or similar. This enables the system (e.g. the XML-parser or the key creator) to check that a specific defining part and a specific markup document comprises the same identification, where the same identification implies that the defining part can be used for creating a compressing key to compress the document in question. It is important that the key identification is unique in the environment where the key and the associated compressed document are to be exchanged. A random algorithm designed to produce numbers with a sufficiently low repeatability is an alternative for generating the identification.

Key Creation

FIG. 4 illustrates a flow diagram showing the main steps of creating 400 a key. The key creation starts by controlling 405 whether a key exists or not. The search for key can be made in the storage device or a common database or a request can be sent to the second application for providing a DTD. If a key does not exist, a DTD is fetched 410 and a key parser 420 is used, which uses, for example the fetched DTD (or an XML-scheme) to create the key. The key is then returned 430 (and/or stored for later access) to the compressor process. In step 400, if it is detected that the key exists, e.g. by going through the storage device index, the key is fetched 440 from the storage device and returned 450 to the application.

With reference to FIG. 2, a compression key can be created by assigning a new code to the markups in a markup document. A code may contain one or several characters that replace the original name of a markup. The example DTD in FIG. 2 contains the elements start, vehicle, head, status, doors and speed. However, the elements start and vehicle contains other elements, i.e. they do not contain any character data. Therefore, no information will be lost if start and vehicle are assigned a new single code. However, if some element, as the element vehicle in this example, comprises one or more attributes the attribute information should preferably be preserved.

The result is that those markups that contain values (character data) will be assigned a new code. In other words, each new code corresponds to the name of the respective markup leading all the way down to the specific value, i.e. the chain or hierarchy of markups that point on a specific value. However, it should be noted that a method or a system or similar is still within the subject matter of this invention, even if it does not assign a code to every markup hierarchy that are defined in a DTD or similar to point on a specific value.

As can be seen in FIG. 2 the compressing key begins with <XMLKey>, which merely points out that this is a compressing key. This introduction is followed by an <info> element comprising a <keyID> element having a value (not showed in the example DTD and the example markup document), which identifies the key as associated with a certain DTD and a certain markup document. It shall be underlined that this is an example and that a compressing key can have many other preludes and/or more extensive preludes without departing from the invention.

The prelude is followed by several <item> elements, which element in turn comprises the elements <code>, <name>, <type> and <format>. These elements will now be described in detail below.

A <code> element contains a new substitution code having less binary size than the original code, where four new codes “a”, “b”, “c” and “d” have been created according to the example in FIG. 2. The first code “a” corresponds to the markup names “start”, “vehicle” and “ok”, which point on the value “yes” in the markup document. The second code “b” corresponds to the markup names “start”, “vehicle” and “doors”, which points on the value “locked” in the markup document, and the third code “c” corresponds to the names “start”, “vehicle” and “speed”, which points on the value “95” in the markup document. The fourth code “d” corresponds to the markup names “start”, “vehicle” and “head”, which points on the entity reference “&lable”.

As can be seen in FIG. 2 the compressing key comprises a <name> element, which contains all the markup names corresponding to a code, contained by the preceding <code> element. In other words, the markup names in the <name> element have been assigned the code comprised by the preceding <code> element.

It should be emphasised that the codes “a”, “b”, “c” and “d” are merely examples of possible codes. Other codes can be used and the codes may contain all possible signs, characters and values. However, a few restrictions can be necessary in some applications, which e.g. use special characters for a predetermined purpose. Nevertheless, a code shall preferably be unique, i.e. a code shall preferably not occur more than once in a certain compressing key. Other solutions are conceivable but not preferred. Certain logic may for example be implemented in the compressing and/or the decompressing algorithms, which can distinguish between identical codes, e.g. by considering the structure of the compressing key. However, such logic may complicate the compressing and/or decompressing and it is therefore not preferred.

Further, a compressing key should preferably comprise information that enables a receiver of a compressed markup document to decompress the document. In the example above this has been implemented by supplying a <type> element, where the element specifies the type of the markup, e.g. attribute, element and reference. Information about the format of the value pointed out by the code has been implemented by supplying a <format> element, where the element specifies the format of the value, e.g. string and integer.

However, the information accompanying the codes above is merely examples of possible information enabling a decompression of the compressed markup document. More and/or other information may be required in some applications.

Compression

A compressing key as described above or another similar or related key may be used to compress and decompress a markup document. A compressed markup document may in turn be structured as a markup document, e.g. as an XML-document. Maintaining a markup structure in the compressed document has the advantage that it enables a parser, e.g. an XML-parser, to check and parse the compressed document. This may be preferred in some applications that e.g. use the compressed document directly, i.e. without any decompression.

An example of a markup style compression of the markup document above may be:

<start a=“yes” b=“locked” c=“95” d=“Motor Vehicle”/>

According to the XML specification, this structure corresponds to an empty element. In this example “start”—i.e. the root-element of the markup document—has been chosen to represent the name of the empty element, whereas “a”, “b”, “c” and “d” represents the attributes of the empty element. It should be noted that the letters “start” could be compressed and substituted as well, e.g. by the letter “s” or some other unique code.

As can be deduced from the <name> element in the compression key according to FIG. 2 the compression has been executed by replacing the elements “start”, “vehicle” and the attribute “ok” with the code “a”. Similarly, the code “b” has replaced the elements “start”, “vehicle” and “doors”, whereas the code “c” has replaced the elements “start”, “vehicle” and “speed” and the code “d” has replaced the elements “start”, “vehicle” and “head”.

Moreover, the code “a” has been assigned the value “yes”, which is the value pointed out by the elements and the attribute corresponding to the code “a”. The code “b” and “c” have in the same way been assigned the value “locked” and “95” respectively, which is the values pointed out by the elements corresponding to the code “b” and “c” respectively.

The remaining code “d” differs from the preceding codes “a”, “b” and “c”, since code “d” does not point out any value, at least not directly. Instead, the elements corresponding to code “d” in this example leads all the way to an entity reference in the markup document, i.e. the entity reference “&lable”. The reference pointed out merely represents the value that should be inserted to replace the reference in the markup document. Consequently, the reference has to be replaced in the compressed document by the value it represents, which in this example is “Motor Vehicle”.

Some markup languages may support more complex references than the simple reference illustrated in this example. A reference may e.g. In turn refer to another reference, which represents the value that shall replace the original reference in the markup document. The relevant code in the compressed markup document should then preferably be assigned the value that will replace the original reference in the markup document. A reference may also refer to whole elements, e.g. predefined in a DTD or similar. The element referred to should then preferably be resolved and assigned a code, where a possible value comprised by the element should preferably be assigned to that code. If a chain of references continues, the same resolving procedure should preferably be repeated.

Further Compression

Although the compression discussed so far can produce a markup character string, e.g. as the string “<start a=“yes” b=“locked” c=“95” d=“Motor Vehicle”/>”, the compression can be carried even further by replacing the blanks and other intermediary characters.

For example the string “<start a=“yes” b=“locked” c=“95” d=“Motor Vehicle”/>” may be represented by the string “a<yes>b<locked>c<95>d<Motor Vehicle>”.

As can be seen this compressed string does not correspond to an empty element according to the XML-standard, which implies that the markup format has been abandoned. The “start” tag has been removed and the quotation and equal characters (=”) has been replace by a “<” character, whereas the quotation and blank characters (”) has been replaced by a “>” character. In addition, if the start and end symbols is removed as in this example it may be necessary to supply other start and end symbols for separating a compressed document from other compressed documents, or more general, from other transmitted data. This can be achieved in many ways, e.g. by the Compression Handler (510) in the Compression part, or by the Packet Handler (555) in the Transmission part.

Moreover, variables and similar that may only adopt one of a limited set of predetermined values can be further compressed. The attribute “ok” has e.g. been defined by the keyword “#IMPLIED”, with the two qualifiers “yes” and “no”, which indicates that if the attribute “ok” is supplied with a value at all in the markup document it has to be either “yes” or “no”. In other words, the attribute “ok” may have three states, i.e. “yes”, “no” or nothing at all. A more general interpretation is that an attribute like “ok” may be assigned one of a limited set of predetermined values, i.e. an attribute “A” may e.g. be assigned on of the values in the limited set {a, b, c, d}. This pre-knowledge can be used to compress the values of attributes, especially since such values may have considerably more characters than the simple “yes” and “no” in this example. One solution is to simply provide the compressing key in with information showing that a first permitted value of an attribute shall be replaced by the number 1, a second permitted value shall be replace by the number 2 and so on. The possible values “yes” and “no” of the attribute “ok” in the example according to FIG. 1 may then be replaced by the numbers “1” and “2” respectively. This means that the code “a” in FIG. 2 can be assigned “1” for replacing “yes”, “2” for replacing “no” and “3” for replacing a blank value. However, blank values may as an alternatively be omitted.

Further, the code “c” has been assigned the characters “95”, comprised by the corresponding “speed” element in the markup document. According to the example in FIG. 2 this corresponds to the integer value 95 contemplated as representing the speed of a vehicle. According to most character sets used in the art of information exchange, a representation of a character usually requires at least one byte (eight ones and/or zeroes), whereas a byte may represent the decimal integer 2⁹−1=255. If two characters are required to represent a number those characters occupy two bytes (sixteen ones and/or zeroes), whereas two bytes may represent the decimal integer 2¹⁷−1=65535. This means that it may be advantageous to replace characters representing number by integers, float or some other number representation.

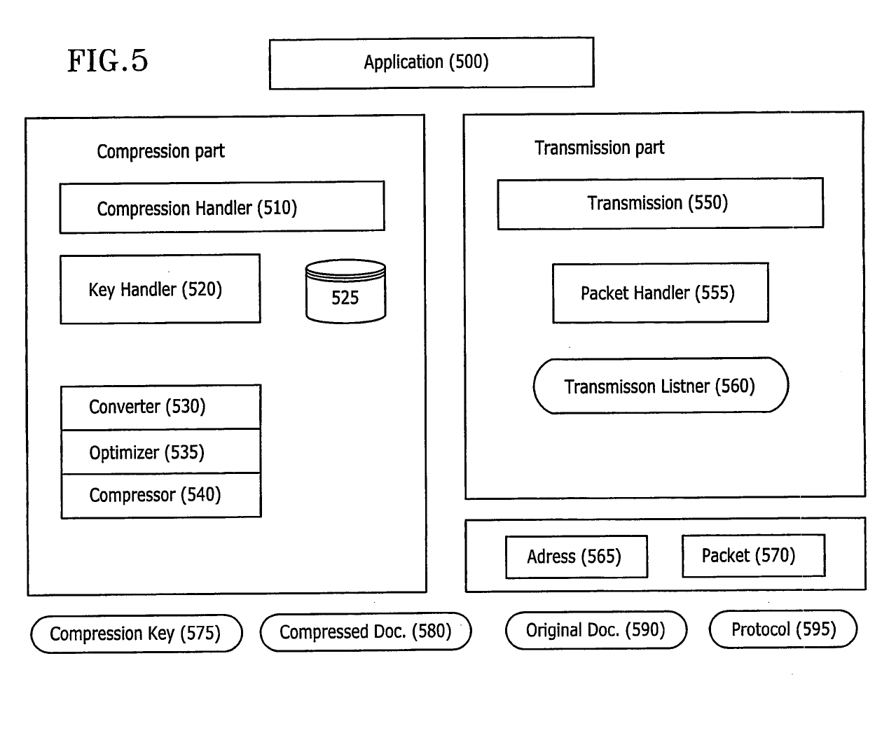

The Compressor according to the best mode of the invention can be realised as a class structure illustrated in the block diagram of FIG. 5. From the Application 500 point of view, a Compression part and Transmission part are generated. The key coding and compression are executed in the Compression part, while building and transmission of packets of compressed information is executed within the Transmission part.

In the Compression part:

Compression Handler, 510, initiates compression procedure and the Application handles all compression by means of this class;
Key Handler, 520, generates and handles the keys;
Database or another storage device, 525, handles the storage of the generated keys.
Converter, 530, implements the first step in the conversion, i.e. coding of the data to be compressed, by mean of the keys;
Optimizer, 535, implements the second step 1n the conversion, i.e. optimizing the data set to be compressed. In the case of XML-document, the structure of the document abandoned.
Compressor, 540, implements the third step, i.e. the compression itself.

The three last mentioned implementations could be realised in a number of ways depending on the demands and requirements.

In the Transmission part:
Transmission, 550, is an abstract class that handles all communication related issues;
Packet handler, 555, generates messages with respect to Packet (570) for transmission and reception.
Transmission Listener, 560, is an interface for listening to data transmission (looking for addressed data package)

There are also a number of help classes, which for example are needed for storing and transmission of data over the network. These are: Compression Key 575, Compressed document 580, Original Document 585 and Protocol 590.

Transmission

As mentioned earlier, a Transporting Agent (FIG. 1) can be used when transmitting compressed data according to the preferred embodiment of the invention. FIG. 5 illustrates the main parts for transmission handling.

All data to be sent is stored in a packet of type Packet 570 by the Application 500. The packets are then processed by the Packet handler 555, in which a message(s) to be transmitted between the applications is generated. Then the sending application sends the packet, e.g. via HTTP or TCP socket.

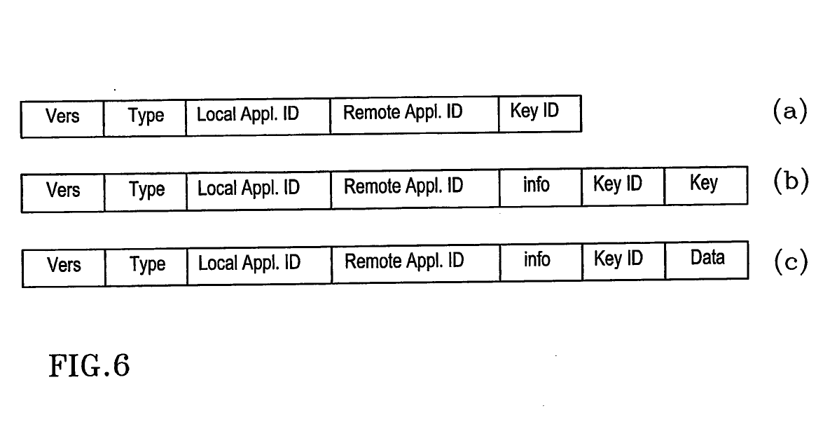

The message to be sent can have different appearances. FIGS. 6a-6c illustrate three examples.

These are for transmitting Key request, Key and Data. The first four fields in an incoming message are used for transmission part, and the remaining fields are handled by the Compression Handler 510.

The fields could be used in the following way:
Vers: contains version of the message format;
Type: contains type of the message, i.e. Keyrequest, Key or Data;
Local Appl. ID: contains the local (transmitting) application identity;
Remote Appl. ID: contains the remote (receiving) application identity;
Key ID: contains the identity of the key connected to the data or the key;
Info: contains information sent to the Compression Handler 510, for example if key is compressed or not;
Key: contains the key used to compress data; it can be compressed or not depending on the contents of Info;
Data: contains Data (e.g. compressed XML document), compressed or not depending on the content of Info.

Each field can be a number bits except for the Data and Key, which obviously must have different sizes. It is appreciated that other fields and packets can be used depending on the requirements and needs.

The Transmission Part handles the generation of a unique Application-ID. Each application using the Compression procedure of the invention preferably needs an application ID so that the transmission part can handle several different applications. The reason is that the receiving application should preferably identify the incoming data and also the keys having unique identity, e.g. based on the application identity.

As it appears from above both the key and the sent data can be compressed. The key and compressed data can additionally be compressed using common compression techniques used for compressing any data. In fact, the compression procedure as described above can use a initial check to find out whether it is worth compressing data using the key compression technique as described. The basis for this can be based on, for example the number of values and tags. If the number of values is more than tags it may be unnecessary to carry out compression according to the invention and only an ordinary compression may be executed. However, the data set (and the generated key) to be transferred after the compression according to the invention can be further compressed using an ordinary compression method, such as PKZIP, Huffman coding, Lempel-Ziv coding, BSTW, Shannon-Fano etc.

Finally, the receiving application based on the key received or pre-stored decompresses the received compressed data set by reversing the compression steps.

The following example disclosed In Table 1 illustrates the efficiently of the compression method of the invention. The test is based on transmitting data through GPRS (General Packet Radio Service). The starting data is an XML document.

TABLE 1

Data quantity

| Doc Size | | Compressed |
|---|---|---|
| (Byte) | XML | XML |
| 104 | 104 | 14 |
| 3141 | 3141 | 419 |
| 102768 | 102768 | 820 |

The invention can be realised both as a hardware and/or software solution; as software it can be implemented in the instruction set memory, as a propagated signal etc.

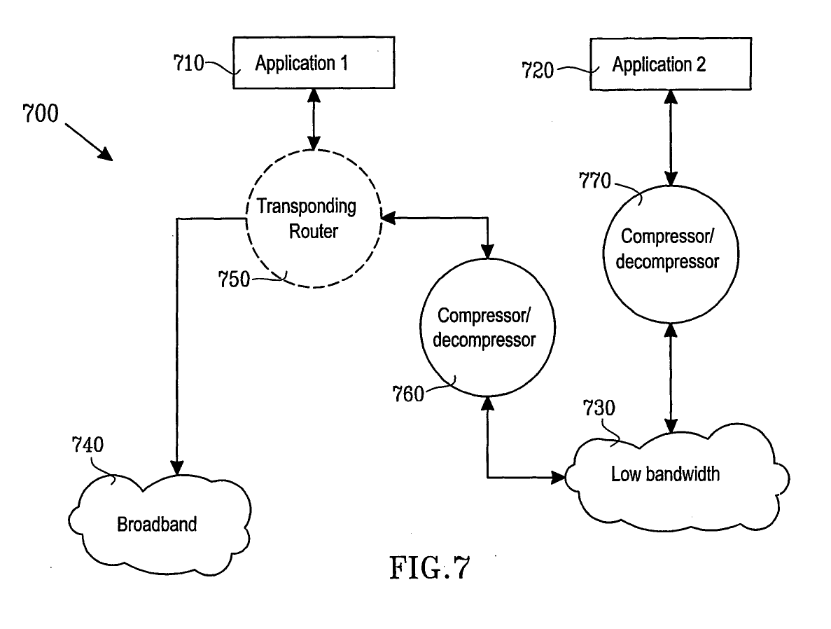

In the following the invention is described with reference to an exemplary implementation 700 illustrated in FIG. 7:

According to this example the applications 710 transmits a data set to application2 720. Application1, for example, can be any of a mobile station, such as a mobile phone, a palm size computer, a computer or similar, used e.g. as a remote control or monitoring device. The application2 can be remotely controlled arrangement such as robot, a vehicle, a missile or the like. The application1 communicates with application2 through a network 730 with a low bandwidth. Application1 may also communicate through a network 740 with high bandwidth.

According to this example, the appilcation1 sends a control message to application1 in form of a XML document. The message originating from the application1 is routed by means of transport router 750, which depending on the addressed destination, the transmitted message to the correct destination. An XML document sent to application2 is passed through a compressing unit 760, as described earlier, which compresses the document and sends it over the low bandwidth network 730 to application2. A decompressing unit 770 decompressed the compressed document before it is received by application2.

If, for example, a response message is sent from applications back to applications the compressing and decompressing units function in a reversed way, i.e. decompressing unit 770 compresses the message and decompressing unit 760 decompresses the message.

The present invention should not be considered as being limited to the above described preferred embodiments, but rather as including all possible variations covered by the scope defined by the appended claims.

1. A method for compressing a data set having a markup hierarchy and comprising data parts having first values, said data set being arranged according to a definition part, the method comprising the steps of:
assigning at least said data parts with codes having less values than said first values,
replacing said data parts in said data set by said assigned codes and producing a compressed data set.

2. The method according to claim 1, wherein said markup hierarchy refer to a reference comprising a second markup hierarchy, which are resolved and assigned with codes.

3. The method according to claim 1, wherein each code is unique.

4. The method according to claim 1, wherein each code replacing a markup hierarchy in said data set is assigned a value pointed out by said markup hierarchy.

5. The method according to claim 1, wherein a code replacing a markup hierarchy in said data set is assigned a value comprised by a reference pointed out by said markup hierarchy.

6. The method according to claim 4, wherein a value pointed out by a markup hierarchy in said data set is one of a limited set of values defined in said data set, where each value is assigned a code that replaces said value in said data set.

7. The method according to claim 4, wherein a value pointed out by a markup hierarchy in said data set is a number and replaced by a numerical representation.

8. The method according to claim 1, wherein said definition part is a document type definition (DTD) or an XML-schema and said data set is a markup document.

9. The method according to claim 8, wherein said markup document is structured according to a markup language as XML, SGML or similar.

10. A method of transmitting a data set from a first application to a second application, said data set having a markup hierarchy and comprising data parts having first values, said data set being arranged according to a definition part, the method comprising the steps of:
generating a set of codes as a compression key defining said data parts defined in said definition part with codes having less values than said first values,
storing said set of codes,
assigning at least said markup hierarchy with said set codes,
replacing said data parts in said data set by said assigned codes and producing a compressed data set, and
transferring said compressed data set and said set of codes to said second application.

11. The method of claim 10, wherein said set of codes and said compressed data are transferred in packages.

12. The method of claim 11, wherein a package comprises at least a message type field, transmitting receiving application identity field, compression key and compressed data.

13. The method of claim 12, wherein a package further comprises a message version field, and contains information sent to the Compression Handler (510), for handling key compression.

14. The method of claim 10, wherein said compression key is transmitted once or several times with each compress data transmission compressed with respect to said compression key.

15. The method according to claim 10, wherein said compression key is compressed.

16. The method according to claim 10, wherein said compressed data is compressed in an additional step.

17. A system for data transmission between at least two stations, said data comprising a compressed data set according to any of preceding claims, the system comprising:
a Compression part, comprising:
a compression Handler (510) for initiating a compression procedure,
a Key Handler (520) for generating and handling keys corresponding to codes;
a Storage device (10,525) for handling storage of generated keys,
a Converter (530) for implementing a first step in coding of the data set to be compressed by mean of the keys;
an Optimizer (535) for implementing a second step in optimizing the data set to be compressed,
a Compressor (540) for implementing a third step of compression itself,
a Transmission part, comprising:
a Transmitter (550) for handling all communication,
a Packet handler (555) for generating messages with respect to a Packet (570) for transmission and reception,
an interface (560) for listening to data transmission.

18. The system of claim 17, further comprising a Compression Key (575) handler, Compression document handler (580), a non compressed data set handler (585) and a Protocol handler (590).

19. The system of claim 17, wherein the Transmission Part handles the generation of a unique Application Identity, so that a receiver can identify incoming data and also the keys having unique identity.

20. A program storage device readable by a machine and encoding a program for compressing a data set having a markup hierarchy and comprising data parts having first values, said data set being arranged according to a definition part, programme comprising:
an instruction set for assigning at least said markup hierarchy defining said data parts defined in said definition part with codes having less values than said first values, and
an instruction set for replacing said data parts in said data set by said assigned codes and producing a compressed data set.

21. A computer readable program code means for causing a computer to compress a data set having a markup hierarchy and comprising data parts having first values, said data set being arranged according to a definition part, the computer readable program code means comprising:
an instruction set for assigning at least said markup hierarchy defining said data parts defined in said definition part with codes having less values than said first values, and
an instruction set for replacing said data parts in said data set by said assigned codes and producing a compressed data set.

22. An article of manufacture comprising a computer useable medium having computer readable programs code means embodied therein for causing a compression of a data set having a markup hierarchy and comprising data parts having first values, said data set being arranged according to a definition part, the computer readable program code means in said article of manufacture comprising:
an instruction set for assigning at least said markup hierarchy defining said data parts defined in said definition part with codes having less values than said first values, and
an instruction set for replacing said data parts in said data set by said assigned codes and producing a compressed data set.

23. A propagated signal comprising a computer readable programs code means for causing a compression of a data set having a markup hierarchy and comprising data parts having first values, said data set being arranged according to a definition part, the computer readable program code means in said propagated signal comprising:
an instruction set for assigning at least said markup hierarchy defining said data parts defined in said definition part with codes having less values than said first values, and
an instruction set for replacing said data parts in said data set by said assigned codes and producing a compressed data set.

24. A computer readable medium having stored therein a protocol with plurality of messages for obtaining compressed data from a remote application, the protocol comprising:
a request message for receiving a set of compressed data set,
a request for receiving a set of codes used for compressing said compressed data set having a markup hierarchy and comprising data parts having first values, said data set being arranged according to a definition part, at least said markup hierarchy defining said data parts defined in said definition part being assigned with codes having less values than said first values, and said data parts being replaced in said data set by said assigned codes,
a response comprising said compressed data and said codes,
a response comprising identity of application and unique identity of codes.

25. A communication system comprising a first unit (710) controlling a second unit (720) communicating through communications network (730), said first unit sending a data set having a markup hierarchy and comprising data parts having first values, said data set being arranged according to a definition part, the system further comprising a compressing unit (760) and decompressing unit (770), wherein said compressing unit is arranged to:
assign at least said data parts with codes having less values than said first values,
replace said data parts in said data set by said assigned codes and producing a compressed data set.

26. The system of claim 25, wherein said first unit (710) is any of a mobile station, a mobile phone, a palm size computer, a computer or similar.

27. The system of claim 25, wherein said first unit (710) is a remote control or monitoring device.

28. The system of claim 25, wherein second unit (720) is a remotely controlled arrangement such as robot, a vehicle, a missile.
